(19) United States
(12) Patent Application Publication
(10) Pub. No.: US 2002/0010745 A1
(43) Pub. Date: Jan. 24, 2002

(54) Method, product, and apparatus for delivering a message

(76) Inventor: Eric Schneider, University Heights, OH (US)

Correspondence Address: ERIC SCHNEIDER, 13944 CEDAR ROAD, # 258, UNIVERSITY HEIGHTS, OH, 44118, US

(21) Appl. No.: 09/733,348

(22) Filed: Dec. 8, 2000

Related U.S. Application Data
(60) Provisional application No. 60/169,861, filed on Dec. 9, 1999.

(51) Int. Cl. G06F 15/16

(52) U.S. Cl. 709/206

(57) ABSTRACT

When a message is received and stored in memory, the message may be parsed to determine whether the message is bounced and returned as undeliverable. When the message is not bounced, then the client may display the message for a recipient to read. When it is determined that the message is bounced, then the client program may parse from the message, the e-mail address and/or any contact information of the intended recipient. At least one URI may be generated from the parsed e-mail address and/or any contact information and the received message may be modified to include a hyperlink reference and/or a redirect command such as a <META> tag REFRESH of the generated URI and the modified message may then be displayed.

### OTHER APPLICATIONS

This application claims the benefit of the following patent application, which is hereby incorporated by reference:

1. U.S. Provisional Application Ser. No. 60/169,861 filed Dec. 9, 1999, by Schneider, entitled “Method and system for finding contact information in response to an undeliverable message.”

### FIELD OF THE INVENTION

This invention generally relates to addressing and messaging systems, and more specifically relates to a method, product, and apparatus for delivering a message.

### BACKGROUND OF THE INVENTION

The Internet is a vast computer network consisting of many smaller networks that span the world. A network provides a distributed communicating system of computers that are interconnected by various electronic communication links and computer software protocols. Because of the internet's distributed and open network architecture, it is possible to transfer data from one computer to any other computer worldwide. In 1991, the World-Wide-Web (WWW or Web) revolutionized the way information is managed and distributed.

The Web is based on the concept of hypertext and a transfer method known as Hypertext Transfer Protocol (HTTP) which is designed to run primarily over a Transmission Control Protocol/Internet Protocol (TCP/IP) connection that employs a standard Internet setup. A server computer may issue the data and a client computer displays or processes it. TCP may then convert messages into streams of packets at the source, then reassemble them back into messages at the destination. Internet Protocol (IP) handles addressing, seeing to it that packets are routed across multiple nodes and even across multiple networks with multiple standards. HTTP protocol permits client systems connected to the Internet to access independent and geographically scattered server systems also connected to the Internet.

Client side browsers, such as Netscape Navigator and/or Microsoft Internet Explorer (MSIE) provide graphical user interface (GUI) based client applications that implement the client side portion of the HTTP protocol. One format for information transfer is to create documents using Hypertext Markup Language (HTML). HTML pages are made up of standard text as well as formatting codes that indicate how the page should be displayed. The client side browser reads these codes in order to display the page. A web page may be static and requires no variables to display information or link to other predetermined web pages. A web page is dynamic when arguments are passed which are either hidden in the web page or entered from a client browser to supply the necessary inputs displayed on the web page. Common Gateway Interface (CGI) is a standard for running external programs from a web server. CGI specifies how to pass arguments to the executing program as part of the HTTP server request. Commonly, a CGI script may take the name and value arguments from an input form of a first web page which may be used as a query to access a database server and generate an HTML web page with customized data results as output that is passed back to the client browser for display.

The Web is a means of accessing information on the Internet that allows a user to “surf the web” and navigate the Internet resources intuitively, without technical knowledge. The Web dispenses with command-line utilities, which typically require a user to transmit sets of commands to communicate with an Internet server. Instead, the Web is made up of millions of interconnected web pages, or documents, which may be displayed on a computer monitor. Hosts running special servers provide the Web pages. Software that runs these Web servers is relatively simple and is available on a wide range of computer platforms including PC's.

A network resource identifier such as a Uniform Resource Identifier (URI) is a compact string of characters for identifying an abstract or physical resource. URIs are the generic set of all names and addresses that refer to objects on the Internet. URIs that refer to objects accessed with existing protocols are known as Uniform Resource Locators (URLs). A URL is the address of a file accessible on the Internet. The URL includes the name of the protocol required to access the resource, a domain name, or IP address that identifies a specific computer on the Internet, and a hierarchical description of a file location on the computer. For example the URL “http://www.example.com/index.html”, where “http” is the scheme or protocol, “www.example.com” is the Fully Qualified Domain Name (FQDN), and “index.html” is the filename located on the server.

Another scheme called the “mailto:” protocol is specifically used for accessing e-mail addresses which take the form “username@hostname.tld”, where “.tld” represents a top level domain such as “.com”, “.net”, “.org”, etc. An e-mail item generally comprises two essential parts: (1) the content, the information one is trying to communicate to recipients and (2) attributes, for example in a heading. Attributes includes such things as the identification of recipients, the date the E-mail message was created, time that the message was sent, the sender or originator, a title or name for the message, and other information about the document that the recipient may be interested in.

An IP address is a 32 bit, non-symbolic number, which represents the unique address of a device connected to the Internet. Before a computer can deliver e-mail, it must first determine the correct recipient IP address. Mappings between hostnames and IP addresses are kept in a distributed database on the Internet called the Domain Name System (DNS). Before the computer transmits its e-mail, it queries the DNS with a host name and waits for the corresponding IP address to be returned. The alternate designated sites for a hostname or domain name are called the hostname's Mail exchanger (MX) hosts. A query of the DNS for the MX information on “mailing@list.com” will return a list of Internet hosts that will accept mail for “list.com”. If no alternate hosts are available, the query will indicate as much.

To transmit an e-mail message, a number of processing steps may be performed before the e-mail message is actually transmitted onto the Internet. Initially, a sending program determines whether it knows the current IP address corresponding to the e-mail hostname or MX hostnames. If not, the sending program queries the DNS for the IP address. The sending program then transmits an initial message to the destination, asking whether the destination computer can receive the e-mail. If the destination computer replies favorably, the sending program breaks the e-mail message up into a series of information packets, and separately transmits each packet. The destination computer receives the packets and reassembles them into the complete e-mail message.

Occasionally, a host site cannot complete delivery of an e-mail message. When this occurs, the host site typically returns (“bounces”) the e-mail message back to the sender with an attached error message explaining why the message could not be delivered. The returned messages are called “bounced messages.” A large number of received bounced messages are burdensome on the system operator, who must manually read through the messages to determine the appropriate action. Some bounces are fatal. A fatal bounce is indicated by, for example, an unknown user or an undeliverable mail message in the subject line of the bounced e-mail.

U.S. Pat. No. 5,937,162 issued on Aug. 10, 1999 by Funk, et al., entitled, “Method and apparatus for high volume e-mail delivery” discloses a system that determines if the message is a fatal bounce, and if so, updates a database to indicate that further e-mail deliveries to that address should be suspended. However, there is no attempt to find alternative means for automatically attempting to contact the recipient. U.S. Pat. 5,944,787 issued on Aug. 31, 1999 by Zoken, entitled, “Method for automatically finding postal addresses from e-mail addresses” provides a system to locate a user's U.S. postal address given the user's e-mail address, but does not consider any means for processing the return of undeliverable messages.

To date, information discovery from contact information and undeliverable message detection have remained separate systems. Accordingly, in light of the above, there is a strong need in the art for a method and system for finding further contact information in response to undeliverable messages.

### SUMMARY OF THE INVENTION

The present invention automatically finds or creates searches for further contact information in response to detecting when a message is bounced or undeliverable. The invention generates URI having a query portion that uses the e-mail address or contact information of the intended recipient as a search request to retrieve more contact information. The present invention uses an executable program to deploy a search agent to extract all contact information with respect to the associated web page of the e-mail address of the intended recipient from the bounced message. The invention finds further contact information by appending a ccTLD to the end of an e-mail address of the intended recipient from the bounced message. The present invention uses an executable program to deploy a search agent to extract all contact information found in a Vcard, signature file, address book, postal address, etc. with respect to the contact information given from an intended recipient.

In general, in accordance with the present invention a method for delivering by a delivery service, a first message from a sender having a sender address to a recipient having a first recipient address includes the steps of receiving the first message by the delivery service, determining that the first message is undeliverable to the first recipient address, adding access information of a locator service to the first message, and providing the first message having the access information to the sender address.

In addition, the access information may be one of a machine-readable code, telephone number, postal address, e-mail address, domain name, and URI and assists the sender in locating the recipient. The sender address and the first recipient address may be an e-mail address and/or postal address and the delivery service may be an e-mail messaging system or postal/parcel service.

Determining that the first message is undeliverable may further include the step of determining that the recipient e-mail address is unknown. Adding the access information to the first message may further include the steps of parsing contact information of the recipient from the undeliverable first message, generating at least one URI from the parsed contact information, and adding the generated URI to the first message. A second message may be generated having the generated URI and the second message may then be provided to the sender address to assist the sender in locating the recipient. Generating the second message may further include the step of generating from the generated URI one of a hyperlink reference, redirect command, and advertisement, which may be added to either the first or second message.

The generated URI may include a query portion having the parsed contact information, which may further include one of a Vcard, signature file, postal address, and the first recipient address. The generated URI may also correspond to the first recipient address. A search agent may be to the generated URI and the contact information of the recipient may be parsed from the generated URI. A second recipient address corresponding to the first recipient address may be generated. The recipient may include a plurality of e-mail addresses wherein it may be determined that at least one e-mail address is unknown from the plurality of e-mail addresses.

The returned first or second message may further includes notifying the sender that the first recipient address is unknown and prompting the sender with possible solutions for finding current contact information of the recipient. Adding the access information may further include the step of inking/stamping the access information to the message and/or envelope of the message and/or attaching the access information to the message and/or envelope of the message.

In accordance with yet additional aspects of the present invention, an apparatus which implements substantially the same functionality in substantially the same manner as the methods described above is provided.

In accordance with other additional aspects of the present invention, a computer-readable medium that includes computer-executable instructions may be used to perform substantially the same methods as those described above is provided.

The foregoing and other features of the invention are hereinafter fully described and particularly pointed out in the claims. The following description and the annexed drawings set forth in detail one or more illustrative aspects of the invention, such being indicative, however, of but one or a few of the various ways in which the principles of the invention may be employed.

### BRIEF DESCRIPTION OF THE DRAWINGS

FIG. 1a is a block diagram of an exemplary distributed computer system in accordance with the present invention.

FIG. 1b is a block diagram illustrating exemplary information records stored in memory in accordance with the present invention.

FIG. 2 is a flowchart illustrating the steps performed for receiving and modifying a bounced message in accordance with the present invention.

FIG. 3a is a flowchart illustrating the steps performed for generating at least one URI from the e-mail address of at least one intended recipient from the bounced message in accordance with the present invention.

FIG. 3b is a flowchart illustrating the steps performed for generating at least one URI from the contact information of at least one intended recipient from the bounced message in accordance with the present invention.

FIG. 4a is a prior art illustration depicting the page source of a bounced message.

FIG. 4b is an illustration of modifications made to the page source of a message in accordance with the present invention,

FIG. 5a is a prior art illustration of an envelope marked Return to Sender by a delivery service.

FIG. 5b is an illustration of an additional marking on the envelope having contact information of a locator service to help a sender locate the recipient in accordance with the present invention.

### DETAILED DESCRIPTION OF THE INVENTION

The present invention will now be described with reference to the drawings, wherein like reference numerals are used to refer to like elements throughout.

Turning first to the nomenclature of the specification, the detailed description that follows represents processes and symbolic representations of operations by conventional computer components, including a local processing unit, memory storage devices for the local processing unit, display devices, and input devices. Furthermore, these processes and operations may utilize conventional computer components in a heterogeneous distributed computing environment, including remote file servers, computer servers, and memory storage devices. These distributed computing components may be accessible to the local processing unit by a communication network.

The processes and operations performed by the computer include the manipulation of data bits by a local processing unit and/or remote server and the maintenance of these bits within data structures resident in one or more of the local or remote memory storage devices. These data structures impose a physical organization upon the collection of data bits stored within a memory storage device and represent electromagnetic spectrum elements.

A process may generally be defined as being a sequence of computer-executed steps leading to a desired result. These steps generally require physical manipulations of physical quantities. Usually, though not necessarily, these quantities may take the form of electrical, magnetic, or optical signals capable of being stored, transferred, combined, compared, or otherwise manipulated. It is conventional for those skilled in the art to refer to these signals as bits or bytes (when they have binary logic levels), pixel values, works, values, elements, symbols, characters, terms, numbers, points, records, objects, images, files, directories, subdirectories, or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, positioning, placing, illuminating, removing, altering, etc., which are often associated with manual operations performed by a human operator. The operations described herein are machine operations performed in conjunction with various input provided by a human operator or user that interacts with the computer. The machines used for performing the operation of the present invention include local or remote general-purpose digital computers or other similar computing devices.

In addition, it should be understood that the programs, processes, methods, etc. described herein are not related or limited to any particular computer or apparatus nor are they related or limited to any particular communication network architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

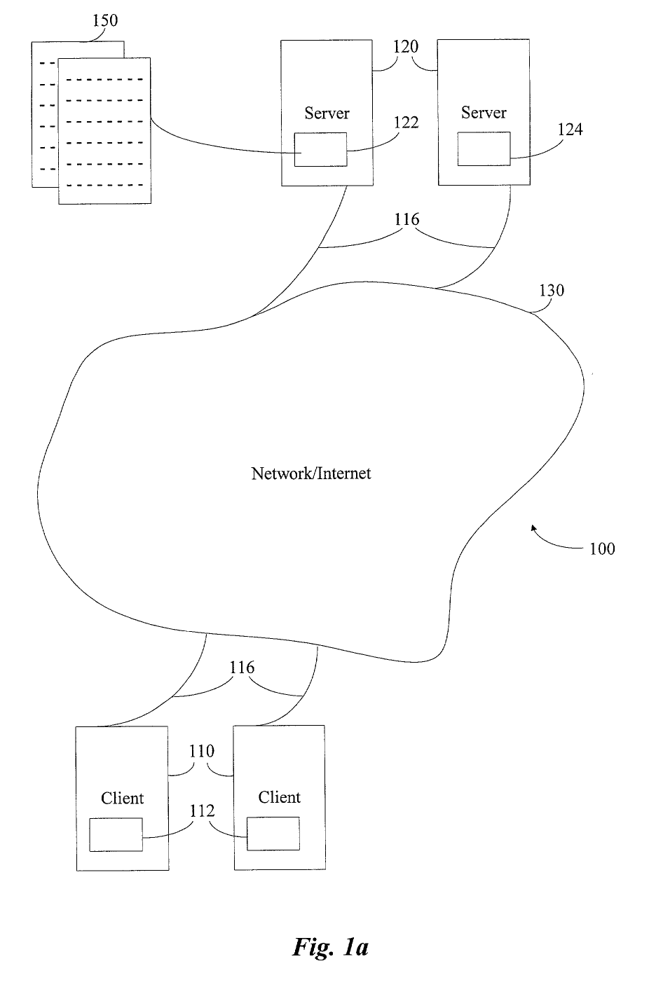

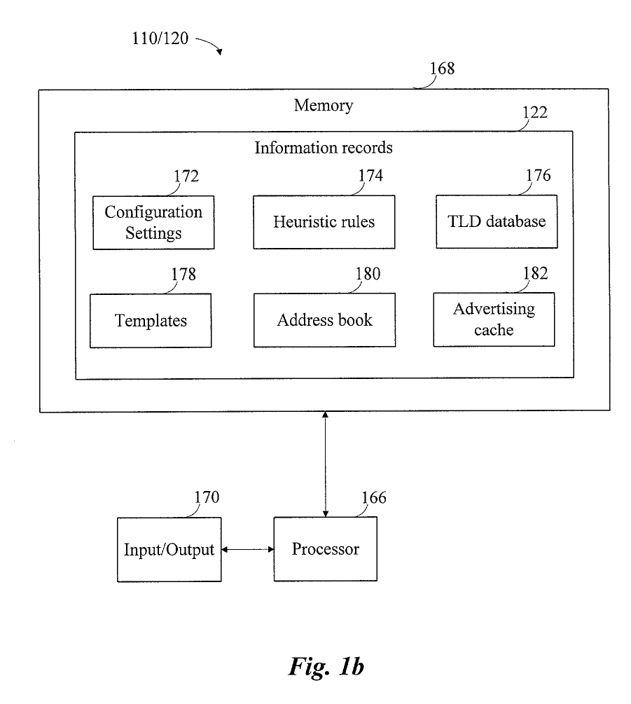

FIG. 1a illustrates an exemplary system for providing a distributed computer system 100 in accordance with one aspect of the present invention and includes client computers or any network access apparatus 110 connected to server computers 120 via a network 130. The network 130 may use Internet communications protocols (IP) to allow the clients 110 to communicate with the servers 120. The communication device of a network access apparatus 1 10 may include a transceiver, a modem, a network interface card, or other interface devices to communicate with the electronic network 130. The network access apparatus 110 may be operatively coupled to and/or include a Global Positioning System (GPS). The modem may communicate with the electronic network 130 via a line 116 such as a telephone line, an ISDN line, a coaxial line, a cable television line, a fiber optic line, or a computer network line. Alternatively, the modem may wirelessly communicate with the electronic network 130. The electronic network 130 may provide an on-line service, an Internet service provider, a local area network service, a wide area network service, a cable television service, a wireless data service, an intranet, a satellite service, or the like.

The client computers 110 may be any network access apparatus including hand held devices, palmtop computers, personal digital assistants (PDAs), notebook, laptop, portable computers, desktop PCs, workstations, and/or larger/smaller computer systems. It is noted that the network access apparatus 110 may have a variety of forms, including but not limited to, a general purpose computer, a network computer, an internet television, a set top box, a web-enabled telephone, an internet appliance, a portable wireless device, a game player, a video recorder, and/or an audio component, for example.

Each client 110 typically includes one or more processors 166, memories 168, and input/output devices 170. An input device may be any suitable device for the user to give input to client computer system 110, for example: a keyboard, a 10-key pad, a telephone key pad, a light pen or any pen pointing device, a touchscreen, a button, a dial, a joystick, a steering wheel, a foot pedal, a mouse, a trackball, an optical or magnetic recognition unit such as a bar code or magnetic swipe reader, a voice or speech recognition unit, a remote control attached via cable or wireless link to a game set, television, and/or cable box. A data glove, an eye-tracking device, or any MIDI device may also be used. A display device may be any suitable output device, such as a display screen, text-to-speech converter, printer, plotter, fax, television set, or audio player. Although the input device is typically separate from the display device, they may be combined; for example: a display with an integrated touchscreen, a display with an integrated keyboard, or a speech-recognition unit combined with a text-to-speech converter.

The servers 120 may be similarly configured. However, in many instances server sites 120 include many computers, perhaps connected by a separate private network. In fact, the network 130 may include hundreds of thousands of individual networks of computers. Although client computers 110 are shown separate from the server computers 120, it is understood that a single computer might perform the client and server roles. Those skilled in the art will appreciate that the computer environment 100 shown in FIG. 1a is intended to be merely illustrative. The present invention may also be practiced in other computing environments. For example, the present invention may be practiced in multiple processor environments wherein the client computer includes multiple processors. Moreover, the client computer need not include all of the input/output devices as discussed above and may also include additional devices. Those skilled in the art will appreciate that the present invention may also be practiced via Intranets and more generally in distributed environments in which a client computer requests resources from a server computer.

During operation of the distributed system 100, users of the clients 110 may desire to access information records 122 stored by the servers 120 while utilizing, for example, the Web. Furthermore, such server systems 120 may also include one or more search engines having one or more databases 124. The records of information 122 may be in the form of Web pages 150. The pages 150 may be data records including as content plain textual information, or more complex digitally encoded multimedia content, such as software programs, graphics, audio signals, videos, and so forth. It should be understood that although this description focuses on locating information on the World-Wide-Web, the system may also be used for locating information via other wide or local area networks (WANs and LANs), or information stored in a single computer using other communications protocols.

The clients 110 may execute Web browser programs 112, such as Netscape Navigator or MSIE to locate the pages or records 150. The browser programs 112 enable users to enter addresses of specific Web pages 150 to be retrieved. Typically, the address of a Web page is specified as a URI or more specifically as a URL. In addition, when a page has been retrieved, the browser programs 112 may provide access to other pages or records by “clicking” on hyperlinks (or links) to previously retrieved Web pages. Such links may provide an automated way to enter the URL of another page, and to retrieve that page.

FIG. 1b illustrates a block diagram of a storage device such as memory 168 in operative association with a processor 166. The processor 166 is operatively coupled to input/output devices 170 in a client 110 and/or server 120 computing system. Stored in memory 168 may be information records 122 having any combination of exemplary content such as lists, files, and databases. Such records may include for example: user modifiable configuration settings 172, heuristic rules 174, TLD database 176, templates 178, address book 180, and advertising cache 182. These information records may be further introduced and discussed in more detail throughout the disclosure of this invention.

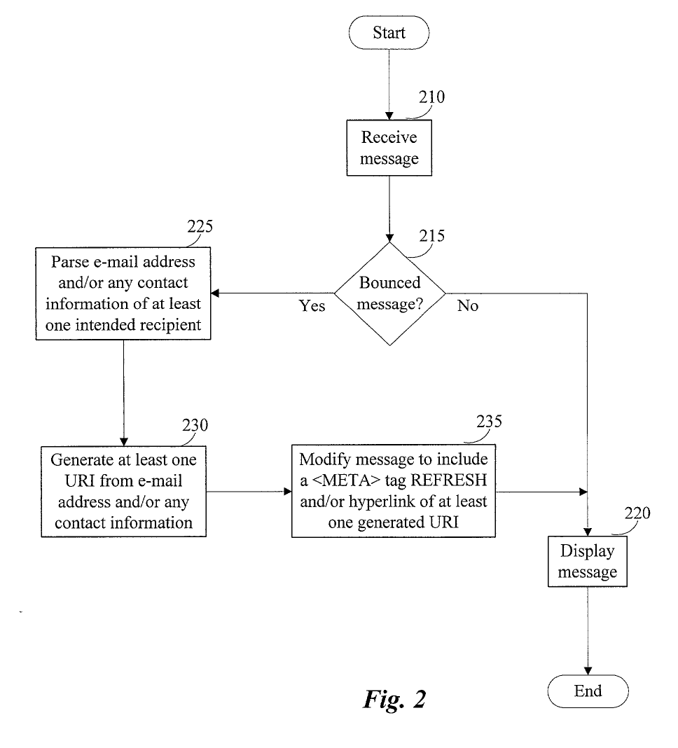

Referring now to FIG. 2, a device, network access apparatus 110, servlet, applet, stand-alone executable program, or web browser 112 is configured to receive a message in step 210 from a message server 120. In a preferred aspect of the present invention, the message server 120 may be configured to store and forward e-mail messages or newsgroup messages to and from at least one client-computing device 110. The messages may be automatically generated or responded, or composed by at least one sender and/or at least one recipient. Recipient postal and e-mail addresses may be stored in an address book 180. When a message is received in step 210 and stored in memory, the message may be parsed to determine in step 215 whether the message is bounced and returned as undeliverable (e.g., destination of recipient e-mail address is not locatable or determined as an unknown user).

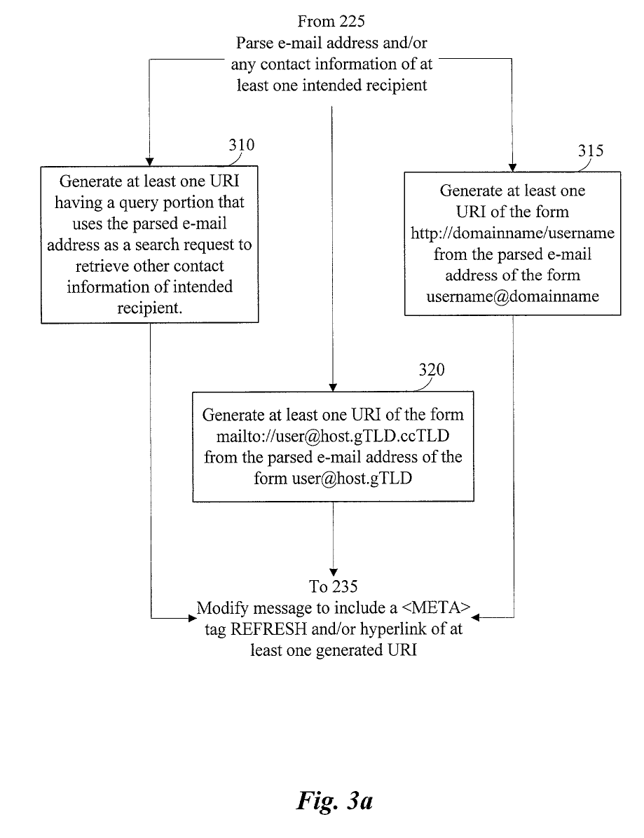

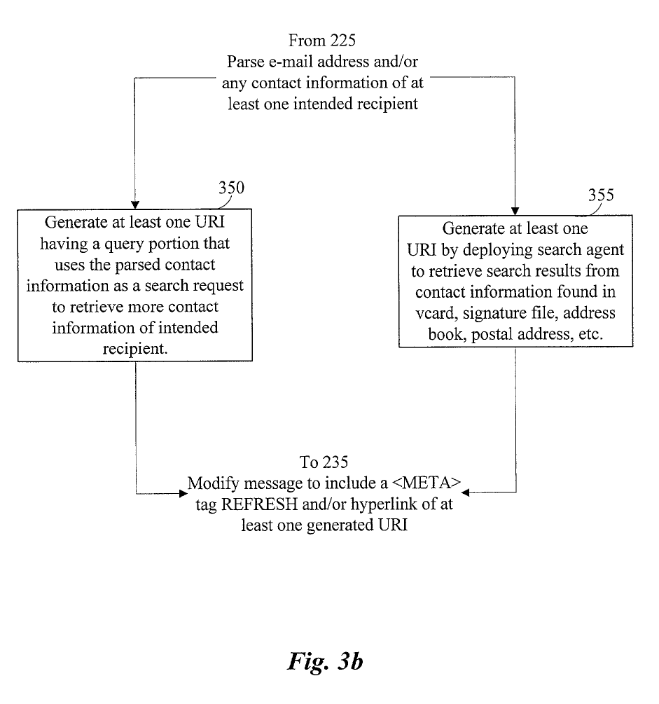

When the message is not bounced then the client 110 displays the message in step 220 for a recipient to read. When it is determined that the message is bounced (step 215), then the client 110 program may parse from the message in step 225, the e-mail address and/or any contact information of the intended recipient. In the case of many recipients, it may be determined, which e-mail address from a plurality of e-mail addresses may be undeliverable. A separate bounced message may be generated for each undeliverable e-mail address. At least one URI may be generated in step 230 from the parsed e-mail address and/or any contact information, and the received message (step 210) may be modified in step 235 to include a hyperlink reference and/or a redirect command such as a <META> tag REFRESH having the at least one generated URI (step 225) and the modified message (step 235) may then be displayed (step 220). URI generation and examples of <META> tags are discussed below in FIG. 3a and FIG. 3b.

Turning now to FIG. 3a, more specific steps may be performed for generating (step 230) at least one URI from the e-mail address of at least one intended recipient from the bounced message as discussed in FIG. 2. After URI generation, steps (235, 220) may be resumed. It is noted that there are many variations of steps used for URI generation that may be used independently or in any combination thereof wherein such steps may also be performed in sequence or in parallel by the executable program.

For example, there are search engines that provide results from white/yellow pages or other directory lookups. By inputting an e-mail address to such a search engine the results of telephone numbers, other e-mail addresses, postal addresses and the like may be retrieved as a means to find further contact information for the intended recipient. The URI of search engines may be stored in either configuration settings 172 or included in templates 178. After at least one e-mail address is parsed in step 225, at least one URI may be generated in step 310 having a query portion that uses the parsed e-mail address as a search request to retrieve other contact information of the intended recipient. For instance, it is determined that the intended recipient of the bounced message is “john@doe.com”. This address may be parsed and used to generate a URI such as “http://search.com/cgi-bin/whitepages/find.cgi?email=john@doe.com”. The message may then be modified (step 235) to include a hyperlink such as:

<A HREF=“http://search.com/cgi-bin/whitepages/find.cgi?email=john@doe.com”>Find john@doe.com</A>

or a <META> tag such as:

<META HTTP-EQUIV=“Refresh” CONTENT=“3; URL=http://search.com/cgi-bin/whitepages/find.cgi?email=john@doe.com”>

An image may also be rendered in conjunction with the hyperlink or URI to display a banner ad. For instance, a locator service such as “Friend Finder” service, who specializes in finding friends, relatives and the like, may display their logo/image in conjunction with the hyperlink that is included in the bounced message that is returned to the sender. Such logos/images may be retrieved from the advertising cache 182 when generating the bounced message on the message server, and returned to the sender.

Another means for finding further contact information is by accessing a web page or homepage that corresponds to the e-mail address. A search agent may be deployed by the program to extract all contact information with respect to the associated web page of the e-mail address. In another step, after at least one e-mail address is parsed (step 225), at least one URI of the form “http://domainname/username” may be generated in step 315 from the parsed e-mail address of the form “username@domainname”. For instance, it is determined that the intended recipient of the bounced message is “john@doe.com”. This address may be parsed and used to generate a URI such as “http://doe.com/john”. The message may then be modified (step 235) to include a hyperlink such as:

<A HREF=“http://doe.com/john”>Find john@doe.com</A>

or a <META> tag such as:

<META HTTP-EQUIV=“Refresh” CONTENT=“3; URL=http://doe.com/john”>

Not all addresses have this exact translated form. For instance, a second URI may be generated “http://doe.com/˜john” in the event the first URI was unsuccessful. Furthermore, rules may be applied based on a given domain as to how the e-mail address maps or corresponds to a user homepage. “johndoe@aol.com” would yield “http://members.aol.com/johndoe”. Rules may be generated and/or stored in a database (not shown) for the “aol.com” or any domain name to translate accordingly.

Yet another means for finding further contact information is by adding a ccTLD to the e-mail address. The ccTLD may be retrieved from a TLD database 176. After at least one e-mail address is parsed (step 225), at least one URI of the form “mailto://user@host.gTLD.ccTLD” may be generated in step 320 from the parsed e-mail address of the form “user@host.gTLD”. For instance, it is determined that the recipient “john@doe.com” of the bounced message is incorrect. A user prompt may be included to suggest to the sender of the message that “john@doe.com.ar” (“.ar” is the ccTLD for Argentina) be used based on previously sent or received messages to or from the intended recipient. This may also operate in the converse. “john@doe.com” inadvertently receives a message from a sender. An analysis having heuristic rules 174 program may be run, which may determine that the message was carbon copied to “jane@doe.com.ar” and that the context of the message was written in another language such as Spanish. Based upon such analysis, it may be suggested to the inadvertent recipient that the letter should be forwarded with an included explanation of the mix up, to the original sender and/or potential recipient “john@doe.com.ar”.

Referring now to FIG. 3b, more specific steps may be performed for generating (step 230) at least one URI from the contact information of at least one intended recipient from the bounced message as discussed in FIG. 2. After URI generation, steps (235, 220) may be resumed. It is noted that there are many variations of steps used for URI generation that can be used independently or in any combination thereof wherein such steps can also be performed in sequence or in parallel by the executable program.

or example, there are search engines that provide results from white/yellow pages or other directory lookups. By inputting an e-mail address to such a search engine the results of telephone numbers, other e-mail addresses, postal addresses and the like may be retrieved as a means to find further contact information for the intended recipient. After any contact information is parsed (step 225), at least one URI may be generated in step 350 having a query portion that uses the parsed contact information as a search request to retrieve further contact information of intended recipient. For instance, it may be determined that the intended recipient of the bounced message is “John Doe, 123 Main St. Cleveland, Ohio 44106”. This contact information may then be parsed and used to generate a URI such as “http://search.com/cgi-bin/whitepages/find.cgi?first=john&last=doe&city=Cleveland&zip=44106”. The message may then be modified (step 235) to include a hyperlink such as:

<A HREF=“http://search.com/cgi-bin/whitepages/find.cgi?first=john&last=doe&city=Cleveland&zip=44106”>Find John Doe</A>

or a <META> tag such as:

<META HTTP-EQUIV=“Refresh” CONTENT=“3; URL=http://search.com/cgi-bin/whitepages/find.cgi?first=john&last=doe&city=Cleveland&zip=44106”>

Another means for finding further contact information on John Doe is by deploying a search agent to retrieve search results from contact information found in a Vcard, signature file, address book, postal address, etc. The contact information from family or friends, such as Jane Doe, or Friend Bill may also be accessed to provide either a profile or degree of accuracy for retrieving more information on John Doe. A URI may then be generated in step 355 based upon the application of heuristic rules 174 to the retrieved contact information as discussed above.

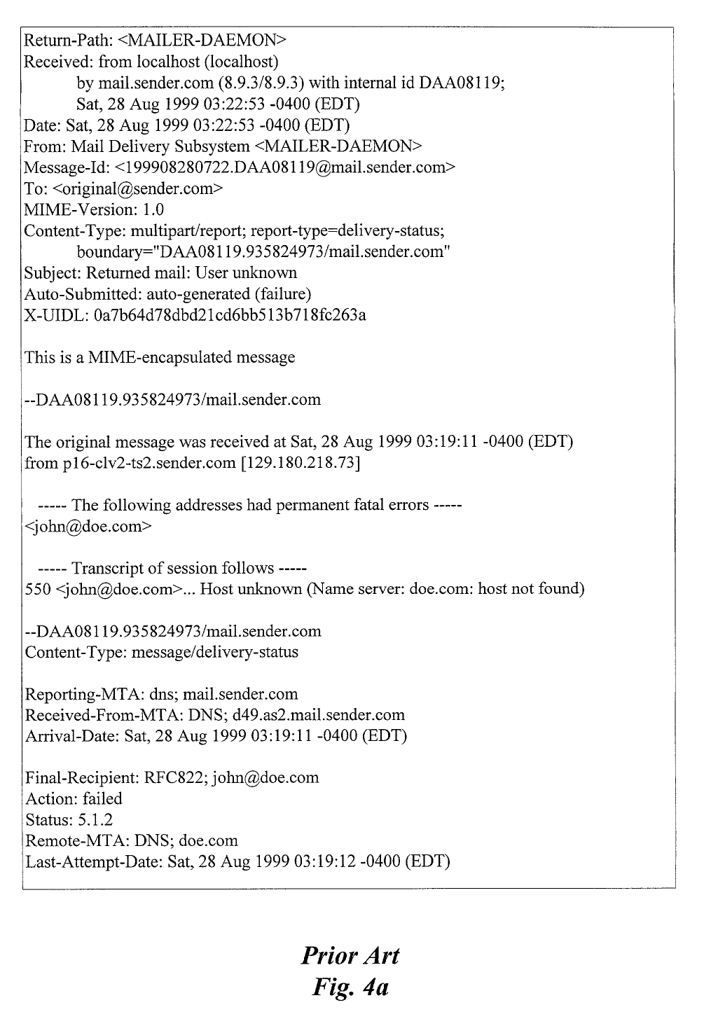

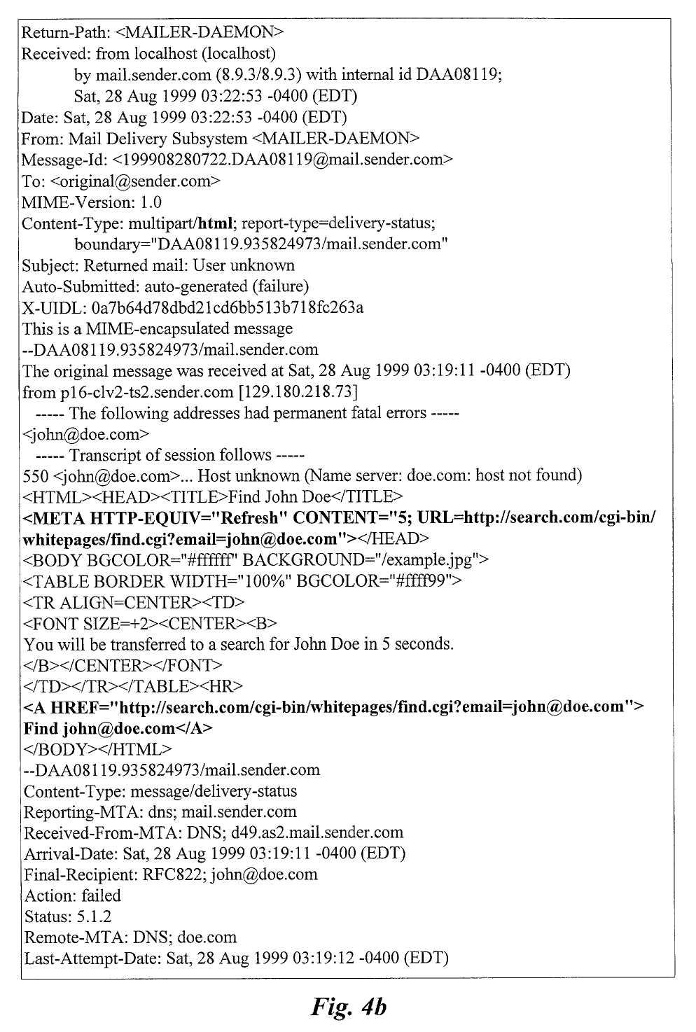

FIG. 4a is a prior art illustration for the page source of a typical bounced message. When such a message is received by either the message client or server, the e-mail address of the intended recipient or recipients may be parsed and the content of the message may be modified with a <META> tag and/or hyperlink reference as discussed above before being displayed by the message client. FIG. 4b illustrates the page source of the modified message as discussed above in FIG. 4a. The <META> tag and/or hyperlink reference is highlighted in bold to show what modifications to the message have been made before received by the client.

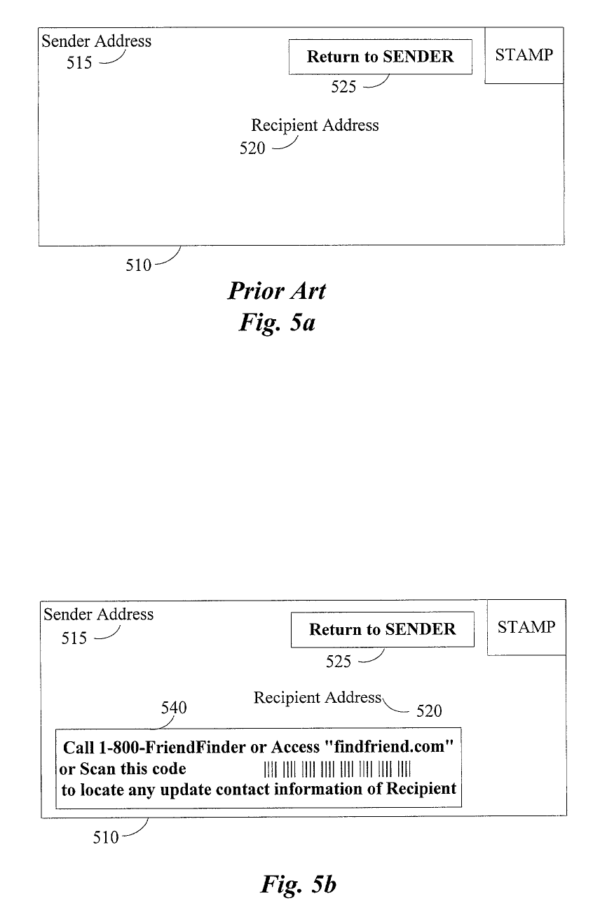

FIG. 5a is a prior art illustration of an envelope having a message. In a delivery service such as a postal or parcel service, a mail piece, parcel, package, postcard, or envelope 510 and the like may be delivered by a carrier from a mailbox, post office, hub, or sender address 515 to a recipient address 520. When a recipient and/or recipient address 520 can not be located, the carrier may initiate a process to return the envelope 510 to the sender address 515. When this is the case the envelope is marked/stamped/inked with the phrase “Return to Sender” 525. The delivery service then routes the envelope 510 accordingly, for delivery to the sender address 515.

FIG. 5b illustrates an additional marking 540 that may be added to the envelope 510 when it is determined that the envelope 510 is to be returned to sender. When a recipient and/or recipient address 520 can not be located, and the envelope is marked/stamped/inked with the phrase “Return to Sender” 525, in addition, the envelope may also be marked/stamped/inked with access/contact information 540 to help the sender find possible solutions for locating current contact information of the recipient. The access information may further include a machine readable code, telephone number, postal address, e-mail address, domain name, or URI and the like as a means for accessing a locator service to help the sender find current contact information for the recipient. The stamped access information may take the form of an advertisement or the like. Adding the access information may further include the step of inking/stamping the access information to the message and/or envelope of the message, and/or attaching the access information to the message and/or envelope of the message.

The invention may be configured for use by any computing device either connected to a network or running in an offline standalone mode. The invention may be installed to operate on any computing device, particularly to those devices connected to a network such as servers, clients, nodes, resolvers, routers, etc. Further aspects of the invention may be employed such as providing an alert when a bounced message is detected. A pop-up window or dialog box may be displayed in response to bounced message detection so the user can decide what method if any to apply to alter the message content. If the invention performs the alteration from a message server rather than a message client, then additional notes such as underlining or comments may be included the in the altered message content so that a user is aware that the received message is altered from the original message. The invention may be configured for any alert, notification, or messaging system including applications such as but not limited e-mail, interactive television, instant messaging, chatrooms, listgroups, newsgroups, gaming, AN conferencing or the like.

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a “means”) used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

I claim:

1. A method for delivering by a delivery service, a first message from a sender having a sender address to a recipient having a first recipient address comprising the steps of:
receiving the first message by the delivery service;
determining that the first message is undeliverable to the first recipient address;
adding access information of a locator service to the first message; and,
providing the first message having said access information to the sender address.

2. A method, as set forth in claim 1, wherein said access information is one of a machine readable code, telephone number, postal address, e-mail address, domain name, and URI and assists the sender in locating the recipient.

3. A method, as set forth in claim 1, wherein the sender address and the first recipient address is an e-mail address and the delivery service is an e-mail messaging system.

4. A method, as set forth in claim 3, wherein said step of determining that the first message is undeliverable further includes the step of determining that said recipient e-mail address is unknown.

5. A method, as set forth in claim 3, wherein said step of adding said access information further includes the steps of parsing contact information of the recipient from said undeliverable first message, generating at least one URI from said parsed contact information, and adding said generated URI to the first message.

6. A method, as set forth in claim 5, further including the steps of generating a second message having said generated URI, and providing said second message to the sender address.

7. A method, as set forth in claim 6, wherein providing said second message to the sender address assists the sender in locating the recipient.

8. A method, as set forth in claim 6, wherein said step of generating said second message further includes the step of generating from said generated URI one of a hyperlink reference, redirect command, and advertisement.

9. A method, as set forth in claim 8, further including the step of adding said one of a hyperlink reference, redirect command, and advertisement to said second message.

10. A method, as set forth in claim 5, wherein said generated URI includes a query portion having said parsed contact information.

11. A method, as set forth in claim 5, wherein said parsed contact information includes one of a Vcard, signature file, postal address, and the first recipient address.

12. A method, as set forth in claim 5, wherein said generated URI corresponds to the first recipient address.

13. A method, as set forth in claim 12, further including the steps of deploying a search agent to said generated URI and parsing said contact information of the recipient from said generated URI.

14. A method, as set forth in claim 1, wherein the recipient includes a plurality of e-mail addresses and said step of determining that the first message is undeliverable further includes the step of determining that at least one e-mail address is unknown from said plurality of e-mail addresses.

15. A method, as set forth in claim 1, further including the step of generating a second recipient address corresponding to the first recipient address.

16. A method, as set forth in claim 1, wherein providing the first message further includes the steps of notifying the sender that the first recipient address is unknown and prompting the sender with possible solutions for finding current contact information of the recipient.

17. A method, as set forth in claim 1, wherein the sender address and the first recipient address is a postal address and the delivery service is a postal service.

18. A method, as set forth in claim 17, wherein said step of adding said access information further includes the step of selecting from one of a inking said access information to the message and attaching said access information to the message.

19. An apparatus for delivering by a delivery service, a first message from a sender having a sender address to a recipient having a first recipient address comprising:
a processor;
a memory in operative association with said processor;
means for receiving the first message by the delivery service;
means for determining that the first message is undeliverable to the first recipient address;
means for adding access information of a locator service to the first message; and,
means for providing the first message having said access information to the sender address.

20. A computer program product for delivering by a delivery service, a first message from a sender having a sender address to a recipient having a first recipient address comprising:
means for retrieving content from a computer network;
means for receiving the first message by the delivery service;
means for determining that the first message is undeliverable to the first recipient address;
means for adding access information of a locator service to the first message; and,
means for providing the first message having said access information to the sender address.
